(19) United States
(12) Patent Application Publication
(10) Pub. No.: US 2004/0034799 A1
(43) Pub. Date: Feb. 19, 2004

(54) Network system allowing the sharing of user profile information among network users

(75) Inventor: Yoshiko Mikami, Kawasaki-shi (JP)

Correspondence Address: Jerry W. Herndon, IBM Corporation T81/503, PO Box 12195, Research Triangle Park, NC, 27709, US

(73) Assignee: International Business Machines Corporation, Armonk, NY

(21) Appl. No.: 10/632,160

(22) Filed: Jul. 31, 2003

(30) Foreign Application Priority Data
Aug. 15, 2002 (JP) 2002-237142

(51) Int. Cl. H04L 9/32; G06F 15/16

(52) U.S. Cl. 713/201; 709/229

(57) ABSTRACT

A network system including a computer used by a first user for displaying a Web page based on data acquired from a server through a network, and a portal server for holding user profile information including basic attributes set by the first user and related attributes set by a second user to permit access by the first user to additional applications under the control of the second user, constructing data for the Web page to be displayed at the computer based on the profile information, including both the user basic attributes and the related attributes, in response to a request from the computer, and sending the constructed data to the computer originating the display request.

### FIELD OF THE INVENTION

This invention relates to a network system delivering content to computers networked to a server, and particularly to a system allowing a user to give another user permission to use part of his or her personal profile information. The preferred embodiment operates in the World Wide Web on host computers that execute the HTTP protocol.

### BACKGROUND

With the recent widespread use of various kinds of information processing equipment such as personal computers, content delivery services using a Wide Area Network such as the Internet have been broadened to include individual users as targets. The contents provided through such a network can be browsed via software with browsing capabilities provided in user equipment. Each individual user can access a site (page) hosted by an Internet Service Provider (hereinafter called “ISP”), a company, or an individual to get desired information or enjoy the service provided.

In general, an individual user accesses a network through a portal as a gateway to a site providing the above-mentioned contents. For example, the individual user can set any favorite site in the browser as the home portal site or the first site user will see when starting the browser. Portal sites hosted by ISPs or companies provide application software (hereinafter called “portal applications”) realizing various contents on Web pages, such as search service, information providing service, community service, and Web Mail service. The individual user can use various kinds of portal applications through the portal sites.

Since typical services offered on a portal site are collectively provided to many users, the amount of content data to be displayed on the browser becomes massive. In this regard, some ISP's or company's portal sites allow each individual user to set his or her user profile information according to the preferences of user. User personal profile information includes the records of service contents to be provided to the individual user, that is, attribute information for using the portal applications, and the records are stored in a predetermined storage device of a portal server provided to deliver the portal site. As a result, when the individual user logs in to the ISP with his or her personal ID and the like, the profile information set by the individual user is read out and content tailored to fit the preferences of user is displayed on the browser. In other words, each individual user can customize his or her own profile information and attribute information on portal applications provided by the ISP so that the ISP or company will provide a portal site containing a customized set of portal applications to the individual user.

As mentioned above, there are portal sites providing portal applications based on profile information on each user. The portal applications are provided by the ISP (from the portal server) to each individual user based on the profile information of user. However, a first user has no means of allowing another user to access services provided by the portal applications based on the profile information of the first user. For example, it would be convenient for an individual user to provide another user with information for sending mail to the individual user or information for money transfer to the individual user through a network system providing portal application services. However, there are no existing network systems capable of implementing such a function.

It is therefore an object of the invention to provide a system capable of allowing a user to use a Web application(s) based on profile information pertaining to a different user.

### SUMMARY

In attaining the above objects, the invention is realized by a network system including the following components, namely: a user terminal for displaying a Web page based on data acquired from a server, and a server for holding profile information including basic attributes pertaining to a first user as information related to contents used by the first user and attributes pertaining to a second user as information related to contents that the the first user is also allowed to use. Data for display on ther first user's terminal is constructed based on the profile information pertaining both to the profiles of the first user and the second user. After data construction, it is sent to the first user terminal originating the display request. The server dynamically constructs the data for the Web page based on the profile information each time the display request is made from user terminal.

The server in the above-mentioned network system may also be realized as a network server having the following features, namely: a profile information store for storing profile information including basic attributes set by a first user for his or her own use and related attributes set by another user for letting the first user use them; a profile information reading part for reading in the profile information on user as a request source in response to the request from the computer terminal; and a Web page constructor for constructing data for the Web page based on the profile information read in by the profile information reading part. The network server may further include an application selector for selecting a predetermined application(s) necessary to construct the data for the Web page based on the related attributes read in by the profile information reading part.

Further, the invention is realized by a network server having the following features. Namely, the network server sending data for a Web page to a computer terminal connected through a network includes display request honoring means for honoring a display request for the Web page from the computer terminal and identifying a user originating the display request, data constructing means for constructing data for displaying the Web page customized by user identified by the display request honoring means while arranging on the Web page contents set by another user for letting user use them, and data sending means for sending the computer terminal the data constructed by the data constructing means so that the Web page will be displayed on the computer terminal.

User terminal in the above-mentioned network system may also be realized as an information processing apparatus having the following features. Namely, the information processing apparatus acquiring data for a Web page through a network includes a display controller for creating, based on the data received through the network, a Web page screen including display contents based on property information set by a user for himself or herself and display contents based on property information set by another user for letting user use it, and a monitor for displaying the Web page screen created by the display controller. The display controller can hide part or all of the display contents based on the property information set by the another user.

The invention further provides an information processing apparatus having the following features, namely: receiving means for receiving data for a Web page through a network; and display means for displaying a Web page customized by a user accessing the Web page based on the data for the Web page received by the receiving means while arranging on the Web page contents set by another user for letting user use them. The display means may display a content for requesting the another user to give permission for the use of any information.

The invention is further realized by the following data processing method for performing predetermined data processing on a computer. Namely, the data processing method includes: a step of honoring a request-to-send from a first user terminal and identifying a user originating the request-to-send; a step of reading in basic attributes set by user and related attributes set by another user for letting user use them from a predetermined storage device according to user identified; and a step of generating data for displaying a prescribed screen on user terminal based on the basic attributes and the related attributes and sending the data to user terminal. The data processing method may also include a step of controlling contents according to property information recorded in the related attributes in response to notification from user that the contents has been selected.

The invention is further realized by the following data processing method for performing predetermined data processing on a computer. Namely, the data processing method includes: a step of accepting access from a first user terminal and identifying a first user making the access; a step of accepting operations from user terminal to set property information referenced when a second user other then the first user accesses and uses contents through a network; and a step of storing the property information in a predetermined storage device. The contents for which the property information is set may include a Web application(s) executable through the network.

The invention is further realized by the following data generating method for controlling a networked computer to generate screen data to be displayed on a first user terminal. Namely, the data generating method includes: a step of honoring a request-to-send from user terminal and identifying a user originating the request-to-send; a step of reading basic attributes set by user and related attributes set by another user for letting user use them from a predetermined storage device according to user identified; and a step of generating data for displaying a prescribed screen on user terminal based on the basic attributes and the related attributes and storing the data in the predetermined storage device.

The invention may realize the above-mentioned method for performing predetermined data processing and data generating method as a program controlling a computer to execute each step or the processing. The program may be distributed in the form of a recording medium such as a magnetic disk, optical disk, semiconductor memory, or any other recording medium, or delivered through a network.

These processing steps allow the creation of profile information on Web applications run on the network server to provide the Web applications to user terminal based on the profile information, thereby increasing the convenience of the portal application providing service between the network server and user terminal.

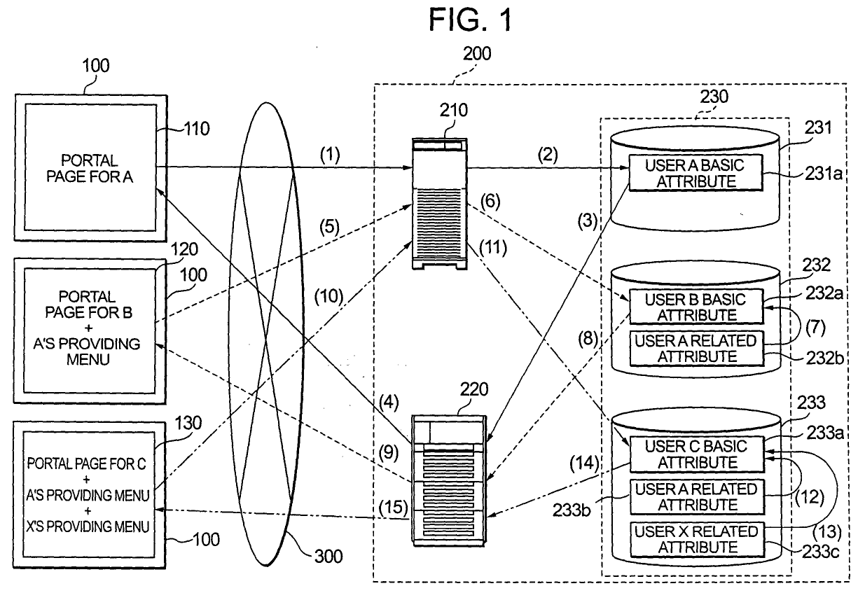

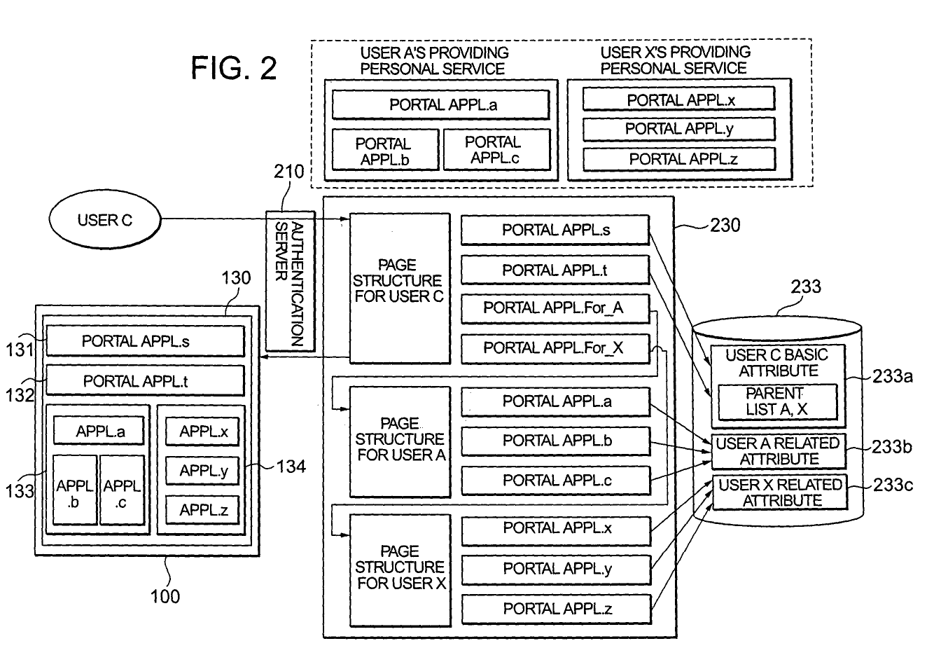

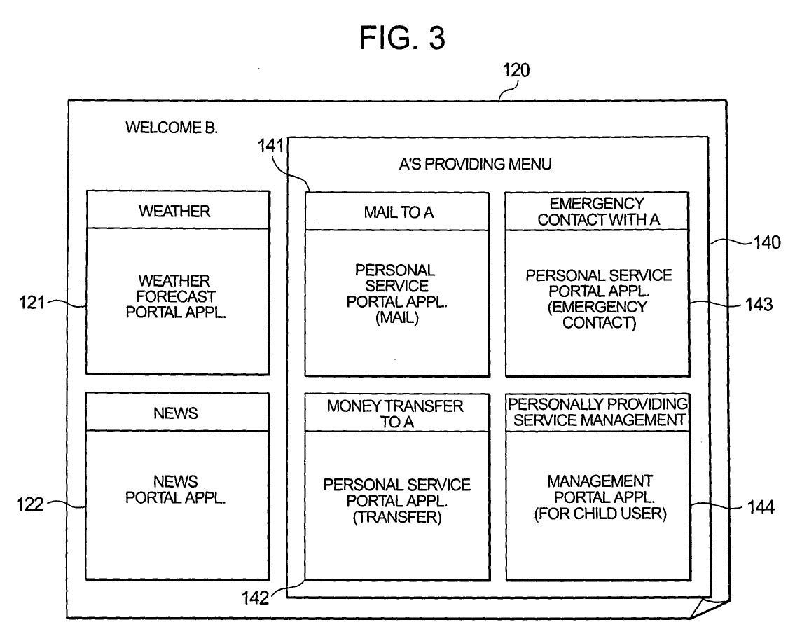

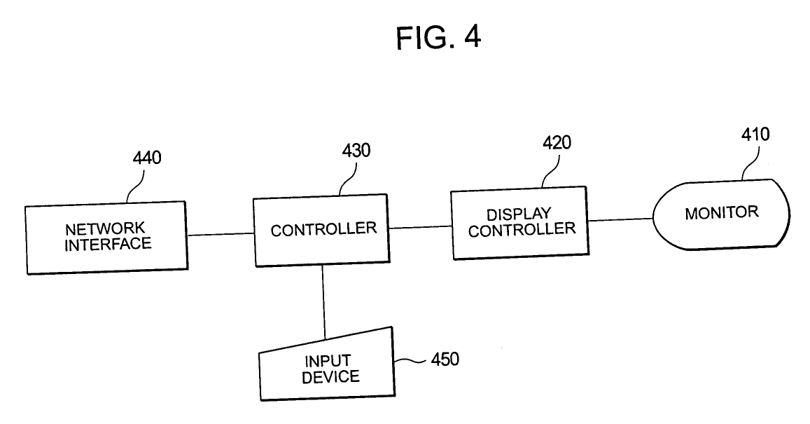

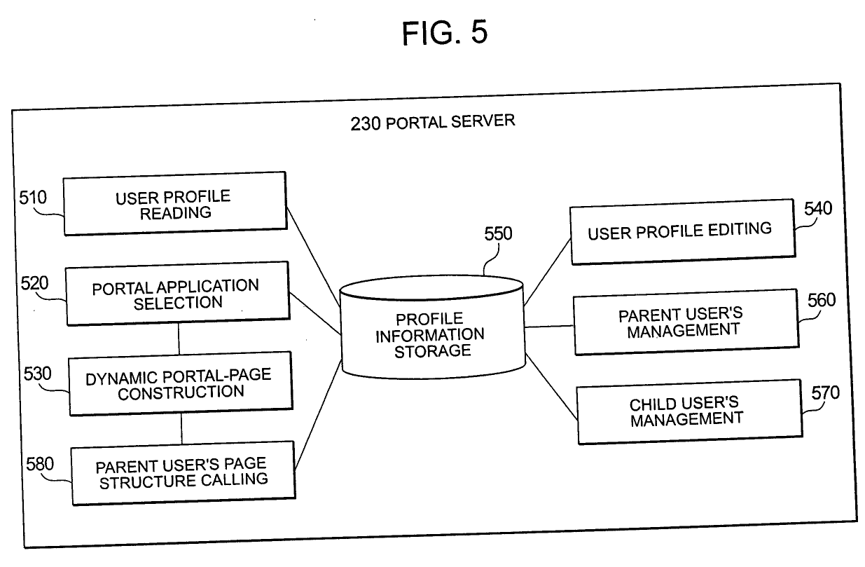

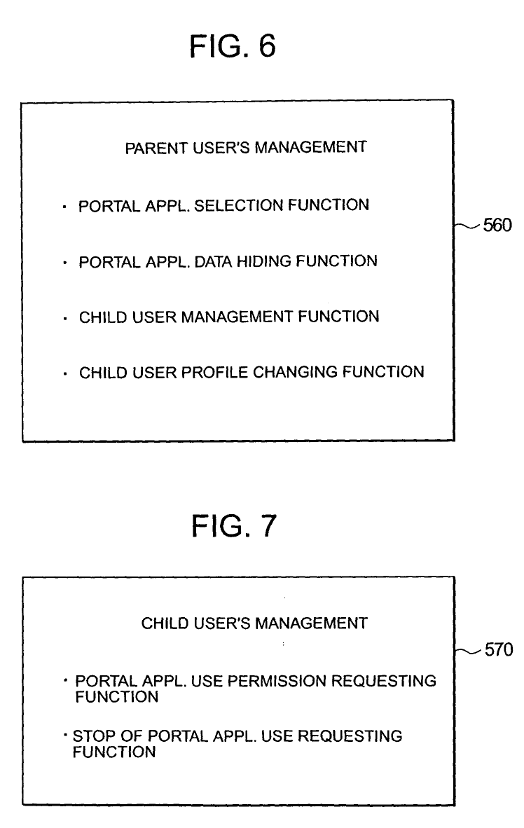

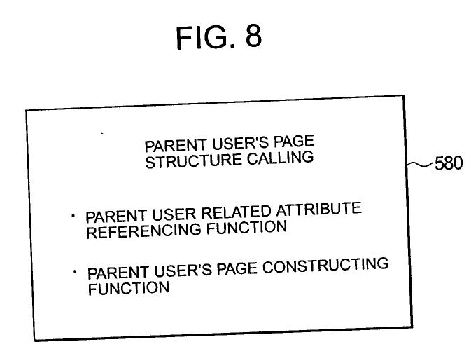

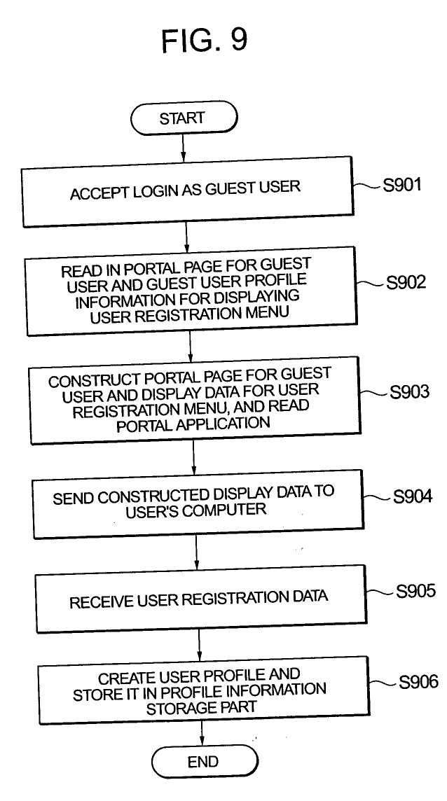

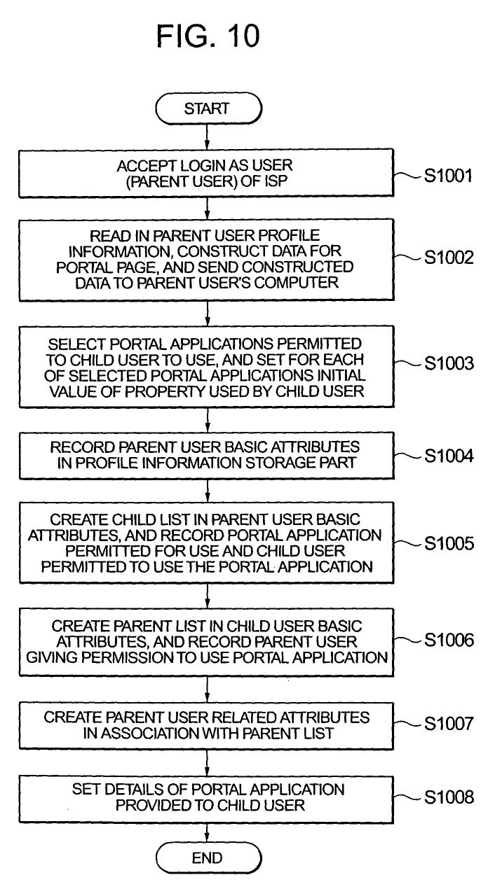

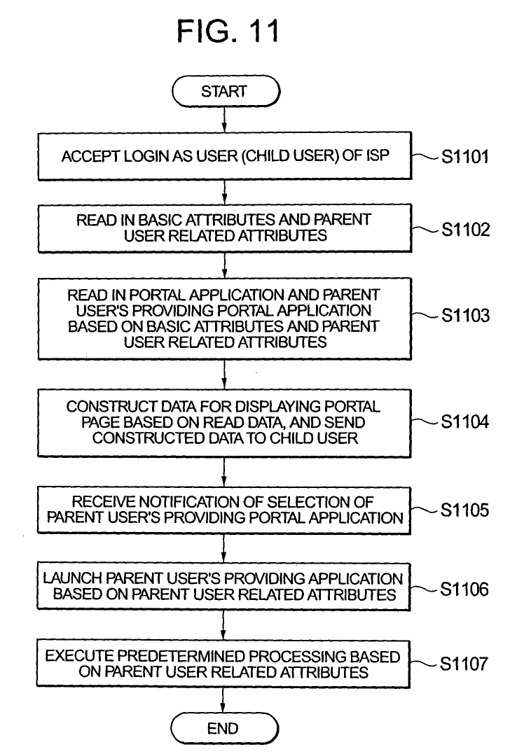

### BRIEF DESCRIPTION OF THE DRAWINGS

[FIG. 1] It is a diagram of a network system showing a general outline of the profile providing service according to the embodiment.

[FIG. 2] It is a diagram showing an example of the data structure of profile information stored in a portal server according to the embodiment.

[FIG. 3] It is a diagram showing an example of the screen structure of a portal page displayed on a monitor of a computer according in the embodiment.

[FIG. 4] It is a block diagram showing a functional configuration of the computer used by each user in the embodiment.

[FIG. 5] It is a block diagram showing a functional configuration of the portal server according to the embodiment.

[FIG. 6] It shows functions implemented by a parent-user's manager of the portal server according to the embodiment.

[FIG. 7] It shows functions implemented by a child-user's manager of the portal server according to the embodiment.

[FIG. 8] It shows functions implemented by a parent user's page structure caller of the portal server according to the embodiment.

[FIG. 9] It is a flowchart showing the flow of processing steps upon registering a user in the portal server according to the embodiment.

[FIG. 10] It is a flowchart showing the flow of processing steps upon permitting a child user(s) to use profile information set by a parent user in the portal server according to the embodiment.

[FIG. 11] It is a flowchart showing the flow of processing steps when a child user getting access rights to use a portal application from the portal server according to the embodiment executes the parent user's providing portal application.

### DETAILED DESCRIPTION

The invention will now be described in detail based on an embodiment illustrated in the accompanying drawings.

A description is first made of the general outlines of the invention. Profile information on Web applications (hereinafter called “portal applications”) set by each individual user in the preferred embodiment is recorded in a predetermined format in a storage device of a portal server. The profile information is created and recorded on a user basis. Permission to use part of user personal profile information is given from one user to another in the preferred embodiment to share part of the profile information about particular portal applications. Alternatively, a system administrator might setup both profiles for the first and second users and the permissions necessary for the first user to share the profile or portion of the profile of the second user. Interconnection (cascading) of the portal application profile information is provided between the first user and the second user to allow the first user to use the particular portal applications based on the profile information permitted by the second user. One user receives access rights to use the contents of another's profile, so that the other user can receive the portal application providing service.

As mentioned above, when the other user receives access rights to use part of the profile information, a Web page (hereinafter called a “portal page”) is displayed on a browser. The portal page includes icons of portal applications provided from the portal server based on profile information set by the other user for himself or herself, and icons of portal applications provided from the portal server based on the profile information provided from the one user. In other words, when the one user permits the other user to use part of the profile information, part of the components of the portal page customized by the one user is taken in as components of the portal page for the other user. The other user can click on an icon displayed on the browser to use a particular portal application according to the profile information permitted to use by the one user.

FIG. 1 is a diagram of a network system showing a general outline of the profile providing service according to the embodiment.

In the network system according to the embodiment, computers 100 used by multiple users are connected to an ISP 200 through a network 300. Each of the computers 100 is equipped with a monitor (not shown) capable of displaying a browser. On each browser, a user A's display screen 110, a user B's display screen 120, or a user C's display screen 130 is displayed based on profile information preset by each user. The ISP 200 includes an authentication server 210, an application server 220, and a portal server 230. The authentication server 210 performs authentication of users accessing from their computers 100. The application server 220 provides a portal application(s) to each user's computer 100 based on profile information (basic attributes and related attributes) set for each user. The portal server 230 stores profile information consisting of information (basic attributes) individualized for each user and information (related attributes) permitted to use by other user(s).

In the network system shown in FIG. 1, each user operates input devices such as a keyboard and a mouse (not shown) to generate a request on the computer 100. In response to the request, the computer 100 sends information unique to user and logs into the ISP 200 through the authentication server 210. The information unique to each user sent to the authentication server 210 may be a user ID and password. When the authentication server 210 confirms the identity of user, profile information on user (information for displaying a portal page) is read from the portal server 230, and a portal application(s) for constructing the portal page is selected from the application server 220 to dynamically construct data for the portal page. The portal page data thus constructed is sent to the computer 100 of user logging-in to the ISP 200. The computer 100 receives the portal page data from the ISP 200 to display a screen on the monitor. The functional configuration of the computer 100 performing this processing and the functional configuration of the portal server 230 is described later using FIG. 4, and FIGS. 5 to 8, respectively.

In FIG. 1, the solid-line arrows (1) to (4) show the steps of displaying a portal page (display screen 110) on user A's computer 100, the dashed-line arrows (5) to (9) show the steps of displaying a portal page (display screen 120) on user B's computer 100, and the arrows with double-dot-and-dash lines (10) to (15) show the steps of displaying a portal page (display screen 130) on user C's computer 100. It is assumed here that user B has received permission from user A to use part of A's portal applications (the provision of a portal page). It is further assumed that user C has received permission from multiple users (user A and user X) to use part of their portal applications.

The following describes the steps of logging in by user A under the assumption that A has not received permission from any other user to use any other application. When information unique to user A is sent from the computer 100 to the authentication server 210 (1), the authentication server 210 performs authentication. If the authentication is successful, user A log into the ISP 200, while if unsuccessful a form indicating authentication failure is sent to the computer 100. The information used for logging into the ISP 200 is sent from the authentication server 210 to the portal server 230 (2). The portal server 230 queries its database to find attributes based on the information. The portal server 230 has a predetermined storage area containing user A profile information 231 consisting of user A basic attributes (profile information set by user A for himself or herself) 231a. The portal server 230 selects a portal application(s) to be read from the application server 220 according to the contents of user A profile information 231, and constructs a portal page (3). The portal server 230 then sends the computer 100 data for the portal page together with the necessary portal application(s) (4). Thus the portal-page display screen 110 for user A is displayed on user A's computer 100.

The following describes the steps when user B and user C receives permission from other user(s) to use their portal page(s). When user B logs in to the ISP 200, information unique to user B is sent from the computer 100 to the authentication server 210 (5), and then from the authentication server 210 to the portal server 230 (6). The portal server 230 has a predetermined storage area containing user B profile information 232 consisting of user B basic attributes (information set by user B for himself or herself) 232a and user A related attributes (part of user A profile information that user A has given user B permission to use) 232b. When the portal server 230 queries its database to find user B attribute information, user B basic attributes 232a and user A related attributes 232b are merged (7) to create the latest user B profile information 232. The portal server 230 selects portal applications to be read from the application server 220 according to the contents of user B profile information 232, and dynamically constructs a portal page (8). The portal server 220 then sends the computer 100 data for the portal page together with the necessary portal applications (9). Thus the display screen 120 containing the portal page for user B and a portal application menu, including applications that user A has permitted user B to use, is displayed on user B's computer 100.

When user C logs in to the ISP 200, information unique to user C is sent to the authentication server 210 (10), and then from the authentication server 210 to the portal server 230 (11) in the same manner as mentioned above in steps (5) and (6). The portal server 230 has a predetermined storage area containing user C profile information 233. User C profile information 233 consists of user C basic attributes (information set by user C for himself or herself) 233a, user A related attributes (part of user A profile information that user A has given user C permission to use) 233b, and user X related attributes (part of user X profile information, which a user X has given user C permission to use) 233c. When the portal server 230 queries its database to find user C attribute information, user A related attributes 233b are merged with user C basic attributes 233a (12), and then user X related attributes 233c are merged (13) to create the latest user C profile information 233. The portal server 230 selects portal applications to be read from the application server 220 according to the contents of user C profile information 233, and dynamically constructs a portal page (14). The portal server 220 then sends the computer 100 data for the portal page together with the necessary portal applications (15). Thus the display screen 130 containing the portal page for user C and portal application menus (portal pages) users A and X have permitted user C to use is displayed on user C's computer 100.

In the example shown in FIG. 1, the authentication server 210, the application server 220, and the portal server 230 are separate pieces of equipment, but these servers provided in the ISP 200 may be combined into a single network server including the following means.

In such a network server, the authentication server 210 is used as display request honoring means and performs user authentication to confirm the identity of user originating the display request. The portal server 230 is used as data constructing means for displaying the portal page based on profile information constructed by user identified by the display request honoring means. The data constructed by the data constructing means include data for arranging various kinds of contents on the portal page, such as an icon(s) of a portal application(s), texts, and images, based on profile information set by other user(s).

The portal server 230 is also used as data sending means for sending data for displaying the constructed portal page to the computer 100 through the network 300. As shown in FIG. 1, upon displaying the portal page on the computer 100 and launching a portal application, the data is sent from the portal server 230 via the application server 220, and data necessary to run the portal application is sent from the application server 220.

The network server including these means can be provided in the ISP 200 for constructing and sending data for a portal page unique to a user each time user makes a display request for the portal page.

FIG. 2 is a diagram showing an example of the data structure of profile information stored in the portal server 230 according to the embodiment. It is assumed that a user permitting another user to use a portal application is called a parent user, and a user permitted by the parent user to use a portal application is called a child user. In the example shown in FIG. 2, a description is made by taking user C as a child user and users A and X as parent users.

As shown, applications that user A has permitted user C to use include a portal application “a” (abbreviated in the figure as “portal APPL.a”), a portal application “b”, and a portal application “c”. Information related to the portal applications provided by user A is held in a predetermined storage area of the portal server 230 as the page structure for user A. On the other hand, personal services provided from user X to user C include a portal application x, a portal application y, and a portal application z, all of which are held in a predetermined storage area of the portal server 230 as the page structure for user X.

The user C basic attributes 233a are contained in the user C profile information 233 on the portal server 230. The user C basic attributes 233a include a list of parent users (parent list) having user C as their child user. In the parent list, user A and user X are recorded. Based on the information recorded in the parent list, user A related attributes 233b and user X related attributes 233c are further contained in user C profile information 233. The personal services provided by user A to user C from the page structure for user A correspond to the portal application a, the portal application b, and the portal application c. On the other hand, the personal services provided by user X to user C from the page structure for user X correspond to the portal application x, the portal application y, and the portal application z.

In other words, the portal page for user C consists of portal applications s and t constructed by user C for himself or herself, and portal applications (abbreviated in the figure as “portal APPL. For_A and portal APPL. For_X”) for calling the portal applications provided from the parent users. Thus the user C profile information 233 for constructing user C's portal page is constructed by merging the portal application a, the portal application b, and the portal application c, with the portal application x, the portal application y, and the portal application z, in addition to the portal applications constructed by user C for himself or herself.

The portal server 230 reads in the user C profile information thus constructed to obtain the page structure for user C. Based on the page structure for user C, portal applications are selected from the application server 220, not shown, to dynamically construct data for the portal page. The constructed portal page data is sent to user C's computer 100. Then the computer 100 constructs the portal page display screen 130 based on the portal page data to display the same in the browser window on the monitor. The display screen 130 is so constructed that the portal application “s” (131) and the portal application “t” (132) are obtained based on the records of user C basic attributes 233a, the portal application “a”, the portal application “b”, and the portal application “c” are obtained based on the records of user A related attributes 233b, and the portal application “x”, the portal application “y”, and the portal application “z” are obtained based on the records of user X related attributes 233c are arranged systematically on the display screen 130.

FIG. 3 shows an example of the screen structure of a portal page displayed on the monitor of the computer 100 according to the embodiment.

FIG. 3 illustrates the structure of a screen on which some of portal applications included in the portal page constructed by user A and personally provided from user A are displayed as user B portal page. As shown, the user B display screen 120 includes a weather forecast application 121 and a news application 122 displayed based on user B basic attributes 232a, and user A's providing menu 140 based on related attributes 232b provided from user A. The A's providing menu 140 includes an e-mail application 141, application 142 for money transfer to user A, application 143 for emergency contact with user A, and a portal management application 144 allowing user B to manage the services provided from user A.

Attribute information for the weather forecast application 121 might include a target region or local area to be displayed; attribute information for the news application 122 might include categories selected and customized by user. Upon displaying the display screen 120 shown in FIG. 3, these kinds of attribute information can be set by user B according to the preferences of user B, and recorded in user B profile information 232 as user B basic attributes 232a.

Each portal application in the A's providing menu 140 is displayed based on the related attributes (user A related attributes 232b in this example) set by the parent user (user A in this example). The related attributes include the records of information on what property the use of each portal application is based. The related attributes include the records of portal applications the parent user permitted the child user to use and properties of the portal applications, and the records can be set or changed by a parent-user manager to be described later using FIG. 6.

The basic attributes set by the child user for himself or herself are merged with the related attributes set by the parent user (user A) to create profile information. The profile information is read in to select portal applications, thereby displaying the A's providing menu 140 on the display screen 120 for the child user (user B in this example).

For example, a destination mail address (mail address held by user A) may be preset as part of user A related attributes 232b for the portal application 141 displayed in the A's providing menu for sending mail to user A.

Information on a transfer destination, such as the name of a financial institution, the name of a branch, and an account number, may also be preset as part of user A related attributes 232b for the portal application 142 for money transfer to user A. Further, telephone numbers for different time periods (telephone numbers possible to reach user A during respective time periods) may be set as part of user A related attributes 232b for the portal application 143 for emergency contact with user A.

It allows the child user just to click on a button or icon of each portal application to use the portal application based on the related attributes set for the application. Since the mail destination address, the detailed information on the transfer destination, and the telephone numbers for emergency contact are all set by the parent user, the child user does not need to go through cumbersome input operations upon using the portal applications. If the mail address or financial institution is changed, the parent user can change it without keeping the child user informed of it, eliminating complexity. In addition, the parent user can set the information such as his or her mail address and transfer destination as hidden so that it will not be displayed on the portal page.

Further, a portal application implementing a function for making a request to the parent user for permission to use the portal applications or profile information, and a portal application implementing a function for making a request to stop the permission to use the portal applications given by the parent user can be displayed as the child-user's managing application 144 in the A's providing menu 140. Like the other portal applications, the portal applications displayed as the child-user's managing application 144 can be displayed in the form of buttons or icons. The functions of the portal applications displayed as the child-user's managing application 144 will be described in detail later using FIG. 7.

FIG. 4 is a block diagram showing a functional configuration of the computer 100 used by each user in the embodiment.

Referring to FIG. 4, the computer.100 includes a monitor 410 for displaying a portal page on the browser, a display controller 420 for controlling the contents of a display screen on the monitor (that is, the display of a portal page), a controller 430 for controlling the entire operation of the computer 100, a network interface 440 for establishing connection to the network 300 such as the Internet, and input devices 450 with which operations such as activation of icons on the display screen of the monitor 410 are performed.

In the functional configuration shown in FIG. 4, the monitor 410 is a display for displaying graphic data created at the display controller 420. The display controller 420 is implemented with dedicated hardware such as a graphic board for creating the graphic data. The controller 430 is a software block implemented by a CPU of the computer 100. The software block holds data for displaying a portal page received through the network interface 440 and sends the data to the display controller 420. The controller 430 performs processing according to the operations done with the input devices 450 such as a mouse and a keyboard in connection with the display screen of the monitor 410. The controller 430 also sends predetermined data to the network 300 through the network interface 440 and to the monitor 410 through the display controller 420. The controller executing these functions includes storage devices such as a main memory and a hard disk drive so that the functions are implemented via a program in the main memory. The program may be distributed in the form of a recording medium, such as a magnetic disk, optical disk, semiconductor memory, or any other recording medium, or delivered through the network. The data and program held in the main memory can be saved into another storage device such as a hard disk as needed.

The computer 100 having the above-mentioned configuration can acquire Web page data from the ISP 200. The Web page data contains contents based on attributes set by a child user on the computer 100 and attributes set by other parent user(s). The display controller 420 creates graphic data for the Web page based on the content data received. The graphic data for the Web page created at the display controller 420 is displayed on the monitor 410. In response to operations performed with respect to the child-user's managing application 144, the display controller 420 can hide part or all of the contents displayed by permission from the parent user(s) to use the property information of the portal applications. If a request is made to the parent user(s) through the child-user's managing application 144 for permission to use another kind of property information, the display control 420 can also display a new portal application based on the new property information the child is permitted to use.

FIG. 5 is a block diagram showing a functional configuration of the portal server 230. The functions of the portal server 230 are contained in software blocks in memory and implemented by a CPU of the portal server 230.

Referring to FIG. 5, the portal server 230 includes a profile information store 550 for storing user profile information in the format of FIGS. 1 and 2. The portal server 230 also includes a user profile reader 510, a portal application selector 520, a dynamic portal-page constructor 530, and a user profile editor 540. User profile reader 510 reads in profile information for a first user (basic attributes of the first user and related attributes provided from other user(s)) from the profile information store 550 after login to the authentication server 210. The portal application selector 520 selects portal applications from the application server 220 based on the profile information of the first user obtained by merging the user's basic attributes and related attributes. The dynamic portal-page constructor 530 dynamically constructs screen data for the portal page based on the selected portal applications, and sends the constructed portal page to the user's computer 100. User profile editor 540 stores in the profile information store 550 user profile information changed by the user himself or herself from user profile information stored in the profile information store 550 or newly created by user. The portal server 230 further includes a parent-user's manager 560, a child-user's manager 570, and a parent-user's page structure caller 580 to be described below using FIGS. 6 to 8.

FIG. 6 shows the kinds of functions implemented by the parent-user's manager 560 of the portal server 230 according to the embodiment.

The parent-user's manager 560 is used by a parent user who permits a child user(s) to use part of the parent user's profile from among all users connectable to the ISP 200 so that the parent user will have the portal server 230 provide portal applications to the child user(s).

The parent-user's manager 560 has a function for selecting a portal application(s) the parent user permits the child user(s) to use, a portal application data hiding function, a child-user management function for managing the child user(s) permitted to use the portal applications, and a child-user profile changing function for individually selecting a portal application(s) permitted to the child user(s) to use, and setting parent-user related attributes necessary to use the portal application(s). Data created by these functions are stored in a storage device such as a hard disk drive provided in the portal server 230.

In the portal application selection function of the parent-user's manager 560, properties to be recorded as initial data in the parent user related attributes in the child-user profile are registered as parent user basic attributes in the parent-user profile. This initial data registration function is performed for each portal application.

In the portal application data hiding function, data on a portal application(s) for which the parent-user profile should not be displayed on a child portal page is hidden from view completely or partially.

In the child user management function, a desired user(s) is selected from among all users registered in the portal server 230 to set as a child user(s) and to be permitted by the parent user to use the parent's portal applications, and as a result, to create a list of child users. In the child-user management function, any user registered in the child-user list can also be deleted from the child-user list.

In the child-user profile changing function, portal application(s) can be selected by a parent for use by a child. In this case, the above-mentioned initial data is recorded in the parent user related attributes in the child-user profile. Further, the parent user related attributes can be changed by the child user, rather than using the initial data as it is, so that even when giving multiple child users permission to use the same portal application, the parent user allows the child users to use the portal application under different use conditions.

FIG. 7 shows the kinds of functions implemented by the child-user's manager 570 of the portal server 230 according to the embodiment.

The child-user's manager 570 is used by a child user who has been permitted by a parent user to use part of the parent user's profile and as a result has gotten access rights to use a portal application(s) from the portal server 230.

The child-user's manager 570 allows a request to the parent user for stopping the use of a portal application by a child, and a request for permission from the parent user for permission to use a predetermined portal application(s). Various data created by these functions are stored in a storage device such as a hard disk drive provided in the portal server 230 in the same manner as the data created by the parent-user's manager 560.

In the portal-application use permission requesting function of the child-user's manager 570, when the child user recognizes that the parent user is using a particular portal application(s) and wants to use the portal application(s), the child user makes a request for permission to use the particular portal application(s). If the parent user is not using the particular portal application(s) the child user wants to use, the child user can also request the parent user to set basic attributes for the particular portal application(s).

In the stop of portal application use requesting function, when a portal application that has already been permitted to use becomes unnecessary, the child user makes a request to the parent user to stop the use of the portal application. Upon receipt of the notification (request), the parent user permits the child user to stop using the portal application, so that the icon of the unnecessary portal application disappears from the display of the portal page of the child user.

FIG. 8 shows the kinds of functions implemented by the parent-user's page structure caller 580 of the portal server 230. The parent-user's page structure caller 580 has a function for referencing parent user related attributes in the child user profile information, and a parent user's page constructing function for writing the structure of the parent user's portal page into the child user's portal page based on the parent user related attributes referenced by the parent-user related attribute referencing function.

In the referencing function of the parent-user's page structure caller 580, the parent user related attributes in the child-user profile is referenced to read in the application(s) the parent user has permitted the child user to use, and the properties necessary to use the application(s).

In the parent-user's page constructing function, the properties of applications are sent to the dynamic portal-page constructor 530 together with the kind(s) of application(s) set by the child user for himself or herself and the child-user basic attributes. The dynamic portal-page constructor 530 constructs data for the portal page to be displayed on the computer 100 of the child user based on these pieces of information. Further, part of the portal application(s) is read out from the application server 220 as needed, and sent to the child user's computer 100 together with the data for the portal page.

As discussed above, the portal server 230 stores the parent user basic attributes, and the basic and related attributes for the child user. Then, when the child user uses the portal application(s) permitted by the parent user, the portal server 230 references the parent user related attributes in the child user profile information, so that the child user uses the portal application(s) based on the parent user related attributes. It allows the child user to use the portal application(s) permitted by the parent user under predetermined use conditions.

The following flowcharts shown in FIGS. 9 to 11 illustrate a money transfer portal application as an example of a portal application permitted for use by the parent user. Referring to these flowcharts, a description is made of the flow of processing steps from when each user is registered in the portal server 230 and a parent user sets a permission to use the money transfer portal application until the money transfer portal application is displayed on a child user's portal page.

FIG. 9 is a flowchart showing the processing steps for registration of a user in the portal server 230.

A user Z who accesses the ISP 200 for the first time logs in as a guest user (step 901). Upon receipt of the notification about the login of user Z, user profile reader 510 of the portal server 230 reads in, from the profile information store 550, a portal page prepared for guest users and guest user profile information for displaying a user registration menu (step 902). The dynamic portal-page constructor 530 constructs data for the portal page for guest users and data for displaying a user registration menu based on the guest-user profile information. The dynamic portal-page constructor 530 then reads from the application server 220 portal applications necessary to construct these data (step 903) and sends the constructed display data to the computer 100 of user Z (step 904).

Based on the received data, image data for the portal page including the portal applications and user registration menu are created on the computer 100 of user Z, and these images are displayed on the browser. It allows user Z not only to use the contents displayed on the portal page, but also to conduct user registration in the ISP 200 according to the user registration menu. User registration data inputted by user Z according to the user registration menu are sent to ISP 200, and received at user profile editor 540 of the portal server 230 (step 905). User profile editor 540 creates profile information (basic attributes) on user Z and stores the profile information in the profile information store 550 (step 906). The basic attributes created in step 906 include information for discriminating one user from another, such as a user ID and password, detailed information related to the user such as name, address, and telephone number, the kinds of portal applications set by user Z, such as a weather forecast portal application, a stock portal application, and a news portal application, and properties necessary to use these portal applications.

Upon completion of user registration, services with limited functions, for example, are made available without any restrictions; alternatively, a portal page customized by the user according to the user preferences can be displayed, thus receiving easy-to-use services.

FIG. 10 is a flowchart of steps allowing a user (lets say a parent user) to establish a set of related attributes for another user as a child user. The parent user sends, for example, his or her user ID and password to the ISP 200 so that the authentication server 210 will accept the login as valid (step 1001). User profile reader 510 reads in the parent user's profile information from the profile information store 550. Then the dynamic portal-page constructor 530 constructs data for displaying a portal page based on the user's profile information, and sends the constructed data to user A's computer 100 for display(step 1002). Upon receipt of the data, a portal page, including a function for generating a child user, is displayed on the monitor 410 of user A's computer 100. Then, when the selection of the portal applications permitted to the child user is made on user A's computer 100, the data obtained with this operation is sent to the ISP 200.

The parent-user's manager 560 of the portal server 230 receives the application data, and selects the portal applications that the parent user has designated from the parent user's basic attributes in the profile information store 550. Then the parent user's manager 560 sets, for each of the selected portal applications, property information to be referenced when the child user uses the portal application (step 1003). The property information set in step 1003 is an initial value of each property information predefined for each of the portal applications. The initial value of each property set in step 1003 is recorded in the profile information store 550 as part of the parent user's basic attributes (step 1004).

The following illustrates a case where the money transfer portal application is selected as the content that the parent user permits the child user to use. In this case, data set as the initial value of the property used when the child user uses the portal application includes information on the transfer destination, such as the name of a financial institution, the name of a branch, and an account number, and information as to whether or not to display each item of the information on the child user's computer 100.

The parent user manager 560 of the portal server 230 further creates a child list in user A basic attributes based on the specification of user A. A parent user's providing portal application(s) (money transfer portal application in this case) permitted to the child user, and the child user(s) permitted to use the parent user's providing portal application(s) are set and stored in the profile information store 550 (step 1005).

Upon completion of the above-mentioned operations with respect to user A (parent user) basic attributes, the parent-user's manager 560 performs processing for changing the profile information on the child user permitted to use the parent user's providing portal application (money transfer portal application) in step 1005. In other words, the parent-user's manager 560 creates a parent list in user B basic attributes read in from the profile information store 550, and sets in the parent list the permission for user B to use the portal application, and records the parent list in the profile information store 550 (step 1006). Based on the contents of user A basic attributes read in from the profile information store 550, user A related attributes are created in association with the parent list (step 1007). The kind of parent user's providing portal application recorded in step 1005 (money transfer portal application in this case), and the initial value of a property referenced upon using the parent user's providing portal application recorded in step 1004 are set in user A related attributes. Further, the details of the property of the portal application permitted to user B are set in response to instructions, if any, from user A; the initial value of the property is overwritten and stored in the profile information store 550 (step 1008). If no special setting of the initial value of the property is needed, step 1008 will be omitted.

FIG. 11 is a flowchart showing the processing steps when a child user executes a parent user's providing portal application. A child user B registered in the ISP 200 and permitted by user A (parent user) to use the parent user's providing portal application (money transfer portal application) sends, for example, his or her user ID and password to the ISP 200 so that the authentication server 210 will accept the login of user B as valid (step 1101). When the login of user B as the child user is accepted, user profile reader 510 of the portal server 230 reads in basic attributes in user B profile information; the parent user's page structure caller 580 reads in user A parent related attributes from the profile information store 550 based on user ID and password (step 1102). Then the portal application selector 520 reads in from the application server 220 a portal application(s) set by user B for himself or herself based on user B basic attributes, and the parent user's providing portal application based on user A related attributes recorded in user B's profile (step 1103). Each of the data such as the read attribute information and the portal application is held, for example, in a memory of the portal server 230 together with a program executing each function in the server 230. The dynamic portal-page constructor 530 constructs data for displaying the portal page on the monitor 410 of user B's computer 100 based on these data, and sends the constructed data to user B's computer 100 (step 1104).

Thus the portal page including the parent user's providing portal application (money transfer portal application) is displayed on display part 410 of user B's computer 100. When the selection of the money transfer portal application for money transfer to user A is made based on the portal page displayed on the monitor 410, data obtained with the operation is sent to the ISP 200.

The portal application selector 520 of the portal server 230 receives the notification of selection of the parent user's providing portal application (money transfer portal application) from user B's computer 100 (step 1105). As a result, the parent user's providing portal application stored in the application server 230 is read and launched based on the parent user related attributes in user B's profile (step 1106). Like in step 1104, the dynamic portal-page constructor 530 constructs data for the money transfer portal application, incorporating information, such as the name of a financial institution, the name of a branch, and an account number, and sends the constructed data to user B's computer 100. Further, when user B operates the computer 100 to send a notification, predetermined processing is executed on the portal server 230 based on user A related attributes in response to the notification sent from the computer 100 (step 1107) so that a money transfer will be made from user B to user A.

The above describes the embodiment on the assumption that respective users (parent and child) are members of the same ISP 200 and can use portal applications provided from the same application server 220, but the embodiment is not limited to this case. The embodiment is also applicable to a case in which user profiles can be mutually provided between portal sites of different ISPs or companies. Further, the embodiment uses the Internet as the network 300 by way of example to explain the invention, but various other networks, such as an intranet, can be used as long as they are connectable to the portal serve 230. Furthermore, the authentication server 210, the application server 220, and the portal server 230 are described as separate servers, but they can be combined into a single server with capabilities equivalent to those in the embodiment.

As described above and according to the embodiment, properties of portal applications permitted to another user under predetermined use conditions can be recorded in profile information to allow the use of portal applications based on the properties. As a result, each user can be provided with the services of portal applications permitted by another user and displayed on a portal page based on each user's individual settings, so that users can use the portal applications under the conditions set by the another user.

In addition, an ISP's or company's site providing the aforementioned services can provide portal applications efficiently, realizing a convenient network system. Such a network system can not only increase the added value of optional services on the site provided by the ISP or company, but also discriminate it from another ISP's or company's network system.

I claim:

1. A method for use in a network system comprising:
storing at a host computer profile information relating to individual users of the host computer, the profile information for a first user and a second user identifying host applications that the first user and the second user, respectively, are permitted to execute,
in response to a request from the first user identifying a list of one or more applications that the first user is permitted to execute, storing the list in the profile of the second user, whereby the second user is permitted to execute the applications in the list under control of the first user.

2. The method of claim 1 wherein the host computer executes any version of the HTTP protocol.

3. The method of claim 1 or claim 2 wherein an application in the list when executed performs a service from the second user to the first user.

4. The method of claim 1 or claim 2 wherein the storing step further comprises storing in the profile of the second user attributes that affect the execution of an application in the list.

5. A host computer for use in a network system comprising:
Means for storing profile information relating to individual users of the host computer, the profile information for a first user and a second user identifying host applications that the first user and the second user, respectively, are permitted to execute,
Means responsive to a request from the first user identifying a list of one or more applications that the first user is permitted to execute for storing the list in the profile of the second user, whereby the second user is permitted to execute the applications in the list under control of the first user.

6. The host computer of claim 5 further comprising means for executing an HTTP protocol.

7. The host computer of claim 5 or claim 6 wherein an application in the list comprises means for performing a service from the second user to the first user.

8. The host computer of claim 5 or claim 6 wherein the storing means further comprises second means for storing in the profile of the second user attributes that affect the execution of an application in the list.

9. A computer product for storing a computer software program, which when loaded into a computer and executed, causes the computer to perform a method comprising:
storing at a host computer profile information relating to individual users of the host computer, the profile information for a first user and a second user identifying host applications that the first user and the second user, respectively, are permitted to execute,
in response to a request from the first user identifying a list of one or more applications that the first user is permitted to execute, storing the list in the profile of the second user, whereby the second user is permitted to execute the applications in the list under control of the first user.

10. The computer product of claim 9 wherein an application in the list when executed by the computer performs a service from the second user to the first user.

11. The computer product of claim 9 or claim 10 wherein the storing step further comprises storing in the profile of the second user attributes that affect the execution of an application in the list.

12. A carrier wave containing a computer software program, which when received and executed by a computer, causes the computer to perform a method comprising:
storing at a host computer profile information relating to individual users of the host computer, the profile information for a first user and a second user identifying host applications that the first user and the second user, respectively, are permitted to execute,
in response to a request from the first user identifying a list of one or more applications that the first user is permitted to execute, storing the list in the profile of the second user, whereby the second user is permitted to execute the applications in the list under control of the first user.

13. The computer product of claim 12 wherein an application in the list when executed by the computer performs a service from the second user to the first user.

14. The computer product of claim 12 or claim 13 wherein the storing step further comprises storing in the profile of the second user attributes that affect the execution of an application in the list.

15. A network server sending data for a Web page in response to a request from a computer terminal connected to the server through a network, comprising:
a profile information store for storing profile information including basic attributes set by a first user for his or her own use and related attributes set by another user for letting the first user use the related attributes;
a profile information reader for reading in the profile information for a user in response to a request from the user; and
a Web page constructor for constructing data for the Web page based on the profile information read in by said profile information reader.

16. A network server according to claim 15, further comprising an application selector for selecting a predetermined application necessary to construct the data for the Web page based on the related attributes read in by said profile information reading part.

17. A network server according to claim 15 wherein the related attributes include information related to applications which the another user has given the first user permission to use, and property information referenced upon using the applications.

18. A network server according to claim 15 wherein said profile information reader merges the basic attributes with the-related attributes concerning a user as the request source and reads in the merged attribute information each time the request is made.
